(19) United States
(12) Patent Application Publication
(10) Pub. No.: US 2012/0050261 A1
(43) Pub. Date: Mar. 1, 2012

(54) 2D-3D SWITCHABLE DISPLAY DEVICE AND METHOD FOR DRIVING SAME

(75) Inventors: SHA FENG, Shenzhen (CN); WEI GUO, Shenzhen (CN)

(73) Assignees: CHIMEI INNOLUX CORPORATION, Miao-Li County (TW); INNOCOM TECHNOLOGY (SHENZHEN) CO., LTD., Shenzhen City (CN)

(21) Appl. No.: 13/031,259

(22) Filed: Feb. 21, 2011

(30) Foreign Application Priority Data
Sep. 1, 2010 (CN) 201010269204.7

(51) Int. Cl. G06T 15/00; G02B 27/26

(52) U.S. Cl. 345/419; 359/465

(57) ABSTRACT

A 2D-3D switchable display device includes a display panel and a polarization element. The display panel includes a plurality of left-eye image regions, a plurality of right-eye image regions alternating with the left-eye image regions, and a plurality of switchable regions each disposed between a corresponding right-eye image region and a left-eye image region adjacent to the corresponding right-eye image region. The polarization element is configured to adjust a left-eye image provided by the left-eye image regions and a right-eye image provided by the right-eye image regions to achieve different polarizations. When the 2D-3D switchable display device works in a 3D mode, each switchable region displays a black sub-image; and when the 2D-3D switchable display device works in a 2D mode, each switchable region displays a gray sub-image.

### BACKGROUND

1. Technical Field

The present disclosure relates to a two-dimensional (2D)-three-dimensional (3D) switchable display device, and a method for driving a 2D-3D switchable display device.

2. Description of Related Art

2D-3D switchable display devices have gained popularity. A commonly used 2D-3D switchable display device includes a display panel and a polarization element including a right-eye image control region and a left-eye image control region. When the 2D-3D switchable display device works in a 3D mode, the display panel displays a right-eye image and a left-eye image, and the right-eye image control region and the left-eye image control region adjust the right-eye image and the left-eye image from the display panel achieve different polarizations such that the right-eye image and the left-eye image can be separated from each other using polarization lenses(such as a pair of polarization glasses).

Moreover, in the 2D-3D switchable display device, a light-shielding layer provided between the right-eye image control region and the left-eye image control region of the polarization element prevents crosstalk in the 3D mode. However, when the 2D-3D switchable display device works in a 2D mode, due to the light-shielding layer, a light transmission ratio of the 2D-3D switchable display device is somewhat low. Thus, 2D image quality of the 2D-3D switchable display device is adversely affected.

What is needed, therefore, is a 2D-3D switchable display device and a method for driving a 2D-3D switchable display device, which can overcome the described limitations.

### BRIEF DESCRIPTION OF THE DRAWINGS

The components in the drawings are not necessarily drawn to scale, the emphasis instead placed upon clearly illustrating the principles of at least one embodiment. In the drawings, like reference numerals designate corresponding parts throughout the various views.

FIG. 1 is an exploded view of a 2D-3D switchable display device according to a first embodiment of the present disclosure.

FIG. 2 is a partial schematic circuit diagram of the 2D-3D switchable display device of FIG. 1, the2D-3D switchable display device including a display panel with a plurality of scanning lines.

FIG. 3 is a first exemplary timing chart of scanning signals provided to the scanning lines of FIG. 2 during a frame period.

FIG. 4A and FIG. 4B show a second exemplary timing chart of scanning signals provided to the scanning lines of FIG. 2 during a frame period.

FIG. 5A and FIG. 5B show a third exemplary timing chart of scanning signals provided to the scanning lines of FIG. 2 during a frame period.

FIG. 6 is a partial schematic circuit diagram of a 2D-3D switchable display device according to a second embodiment of the present disclosure.

FIG. 7 is a partial schematic circuit diagram of a 2D-3D switchable display device according to a third embodiment of the present disclosure.

FIG. 8 is a flowchart of a method for driving a 2D-3D switchable display device according to an embodiment of the present disclosure.

### DETAILED DESCRIPTION

Reference will now be made to the drawings to describe certain exemplary embodiments of the present disclosure in detail.

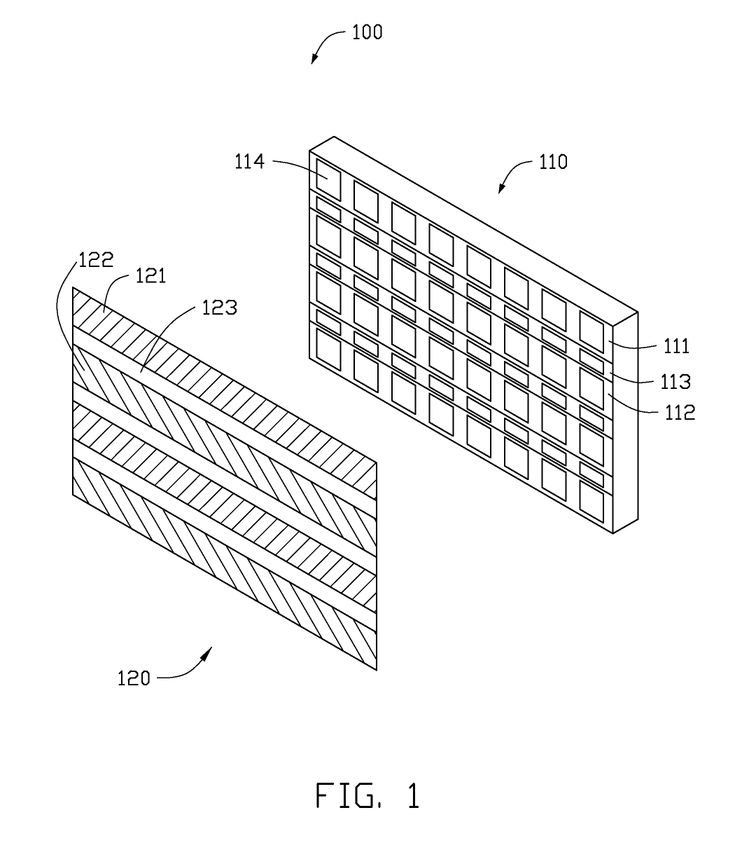

FIG. 1 is an exploded view of a 2D-3D switchable display device according to a first embodiment of the present disclosure. The 2D-3D switchable display device 100 includes a display panel 110 and a polarization element 120. The polarization element 120 is located adjacent to a display surface of the display panel 110.

The display panel 110 includes a plurality of left-eye image regions 111, a plurality of right-eye image regions 112, and a plurality of switchable regions 113. The right-eye image regions 112, the left-eye image regions 111, and the switchable regions 113 may have elongated shapes and extend along a first axis (such as a horizontal axis). The right-eye image regions 112 alternate with the left-eye image regions 111 one by one in a second axis (such as a vertical axis) perpendicular to the first axis. Each of the switchable regions 113 is located between a corresponding right-eye image region 112 and a left-eye image region 111 adjacent to the corresponding right-eye image region 112, such that the corresponding right-eye image region 112 and the left-eye image region 111 can be separated from each other.

The display panel 110 further includes a pixel matrix having a plurality of pixels 114. In the illustrated embodiment, each of the left-eye image regions 111 corresponds to one row of pixels 114, each of the right-eye image regions 112 corresponds to one row of pixels 114, and each of the switchable regions 113 corresponds to one row of pixels 114. In an alternative embodiment, each of the right-eye image regions 112, the left-eye image regions 111 corresponds to two adjacent rows of pixels 114, and the switchable regions 113 corresponds to one row of pixels 114.

In the illustrated embodiment, a width of the left-eye image region 111 may be same as that of the right-eye image region 112, and may be greater than that of the switchable region 113. Accordingly, an area of the left-eye image region 111 is the same as that of the right-eye image region 112, and is greater than that of the switchable region 113. An area ratio of the switchable region to the left-eye image region 111 may be in the range from greater than or equal to 0.1 to less than or equal to 0.5, and is 0.263, in one example.

The polarization element 120 may be a polarization plate, and includes a plurality of first polarization regions 121 corresponding to the left-eye image regions 111, a plurality of second polarization regions 122 corresponding to the right-eye image regions 112, and a plurality of dummy regions 123 corresponding to the switchable regions 113. The first polarization regions 121 and the second polarization regions 122 are configured to adjust a left-eye image provided by the left-eye image regions and a right-eye image provided by the right-eye image regions to achieve different polarizations such that the right-eye image and the left-eye image are separated from each other using polarization lenses.

In one embodiment, each of the first polarization regions 121 may adopt a polarization film with a first polarization axis, and each of the second polarization regions 122 may adopt a polarization film with a second polarization axis perpendicular to the first polarization axis, such that light from the left-eye image is adjusted to a first linear polarization orientation by the first polarization regions 121, and light from the right-eye image is adjusted to a second linear polarization orientation perpendicular to the first linear polarization orientation by the second polarization regions 122. Accordingly, the right-eye image and the left-eye image are separated from each other using polarization lenses which include a left lens having a polarization film with the first polarization axis and a right lens having a polarization film with the second polarization axis.

In an alternative embodiment, each of the first polarization regions 121 may adopt a right-hand polarization film, and each of the second polarization regions 122 may adopt a left-hand polarization film, such that light from the left-eye image is adjusted to right-hand circularly polarized light by the first polarization regions 121, and light from the right-eye image is adjusted to left-hand circularly polarized light by the second polarization regions 122. Accordingly, the right-eye image and the left-eye image are separated from each other using polarization lenses which include a left lens having a right-hand polarization film and a right lens having a left-hand polarization film.

Each of the dummy regions 123 is a light transmission region, that is, light from the corresponding switchable region 113 can pass through the dummy region 123. The dummy region 123 may adopt a polarization film matching the polarization film of the first polarization region 121 or the second polarization region 122, and the dummy region 123 is preferably a transparent film having a high light transmission ratio.

When the 2D-3D switchable display device 100 works in a 3D mode, each of the left-eye image regions 111 displays a left-eye sub-image, each of the right-eye image regions 112 displays a right-eye sub-image, and each of the switchable regions 113 displays a black sub-image. The left-eye sub-images displayed by the left-eye image regions 111 cooperatively constitute a left-eye image, the right-eye sub-images displayed by the right-eye image regions 112 cooperatively constitute a right-eye image, and the black sub-images displayed by the switchable regions 113 cooperatively constitute a black image. The switchable regions 113 display the black image, that is, each pixel 114 in the switchable regions 113 has a lowest light transmission ratio. Each of the first polarization regions 121 adjusts the left-eye sub-image provided by the corresponding left-eye image region 111 to achieve a first polarization, and each of the second polarization regions 122 adjusts the right-eye sub-image provided by the corresponding right-eye image region 112 to achieve a second polarization different from the first polarization, such that the left-eye image provided by the left-eye image regions 111 and the right-eye image provided by the right-eye image regions 112 achieve the first polarization and the second polarization respectively, and the left-eye image and the right-eye image can be separated from each other using polarization lenses.

When the 2D-3D switchable display device 100 works in a 2D mode, each of the left-eye image regions 111, the right-eye image regions 112, and the switchable regions 113 displays an ordinary gray sub-image, displayed by the left-eye image regions 111, the right-eye image regions 112, and the switchable regions 113 constitute an ordinary gray image which is a 2D image. Specifically, each of the left-eye image regions 111, the right-eye image regions 112, and the switchable regions 113 is used as an ordinary display region to display gray sub-image based on 2D image data. In one embodiment, a row of pixels 114 in each switchable region 113 displays a gray sub-image matching a gray sub-image displayed by an adjacent row of pixels 114 in the adjacent right-eye image region 112 or the adjacent left-eye image region 111. For example, if the switchable regions 113 are divided to a plurality of first switchable regions 113a and a plurality of second switchable regions 113b alternating with the first switchable regions 113a, the row of pixels 114 in each first switchable region 113a displays a gray sub-image matching a gray sub-image displayed by an adjacent row of pixels 114 in the adjacent right-eye image region 112, and the row of pixels 114 in each second switchable region 113b displays a gray sub-image matching a gray sub-image displayed by an adjacent row of pixels 114 in the adjacent left-eye image region 111.

Due to the black image displayed by the switchable regions 113 in the 3D mode, crosstalk between the left-eye image and the right-eye image may be reduced. Furthermore, in the 2D mode, the switchable regions 113 display the ordinary gray sub-images and light from the switchable regions 113 can pass through the dummy region 123, such that light transmission ratio in the 2D mode can be improved.

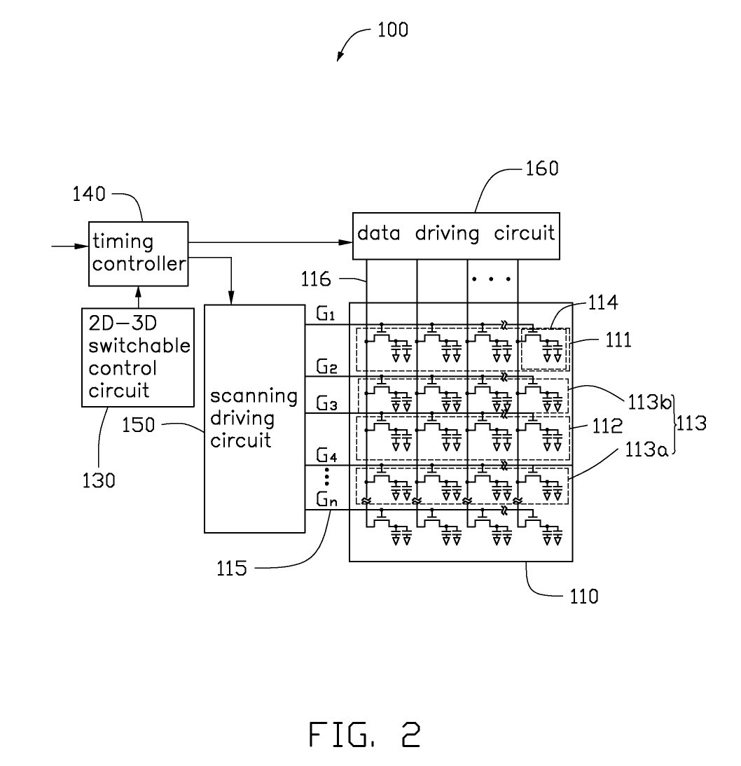

The display panel 110 may be a liquid crystal panel, a plasma display panel (PDP) or an organic light emitting diode (OLED) panel. The present disclosure uses the liquid crystal panel as an example to describe a schematic circuit and operation of the 2D-3D switchable display device 100 in detail. Referring to FIG. 2, a partial schematic circuit diagram of the 2D-3D switchable display device 100 is shown. The display panel 110 shown in FIG. 2 is a liquid crystal panel. The 2D-3D switchable display device 100 further includes a 2D-3D switchable control circuit 130, a timing controller 140, a scanning driving circuit 150, and a data driving circuit 160. The 2D-3D switchable control circuit 130 and the timing controller 140 can be integrated in one chip. The scanning driving circuit 150, and the data driving circuit 160 may be integrally formed with the display panel 110.

The 2D-3D switchable control circuit 130 is configured to provide a display mode control signal to the timing controller 140. The timing controller 140 is configured to receive image data and the display mode control signal, process the image data according to the display mode control signal, and output a timing control signal for controlling timing of the scanning driving circuit 150 and the data driving circuit 160 and a data signal. The scanning driving circuit 150 is configured to receive the timing control signal and output a plurality of scanning signals to the display panel 110 based on the timing control signal. The data driving circuit 160 is configured to receive the data signal and the timing control signal and output a plurality of data voltages to the display panel 110 based on the data signal and the timing control signal.

In one embodiment, the 2D-3D switchable control circuit 130 may receive the image data and determine that the image data are 3D image data or 2D image data so as to generate the display mode control signal.

The display panel 110 further includes n rows of parallel scanning lines 115 extending long the first axis (where n is a natural number) for receiving the scanning signals, and m columns of parallel data lines 116 perpendicular to the scanning lines 115 (where m is also a natural number) extending along the second axis for receiving the data voltages. The pixels 114 of the pixel matrix are cooperatively defined by intersecting scanning lines 115 and data lines 116. Each of the right-eye image region 112, the left-eye image region 111, and the switchable region 113 corresponds to one row of pixels 114 respectively.

When the 2D-3D switchable display device 100 is in the 3D mode, the 2D-3D switchable control circuit 130 provides a 3D mode control signal to the timing controller 140. The timing controller 140 receives 3D image data and the 3D mode control signal, and generates a timing control signal and a data signal accordingly. Moreover, the timing controller 140 also outputs the timing control signal to the scanning driving circuit 150 and the data driving circuit 160, and outputs the data signal to the data driving circuit 160. The scanning driving circuit 150 generates and applies scanning signals to the scanning line 115 according to the timing control signal so as to activate the pixels 114 row by row. The data driving circuit 160 converts the data signal into data voltages and outputs the data voltages to the data lines 116 to charge the activated pixels 114. Upon receiving the data voltages, the pixels 114 in the left-eye image regions 111 display a left image, the pixels 114 in the right-eye image regions 112 display a right image, and the pixels 114 in the switchable regions 113 display a black image.

In one embodiment, each of the data voltages provided to the pixels 114 in the switchable regions 113 is a black insertion voltage, and the black insertion voltage is provided to the pixels 114 in the switchable regions 113 by use of black insertion technology.

When the 2D-3D switchable display device 100 is in the 2D mode, the 2D-3D switchable control circuit 130 provides a 2D mode control signal to the timing controller 140. The timing controller 140 receives 2D image data and the 2D mode control signal, generates a timing control signal and a data signal according to the 2D image data and the 2D mode control signal. Moreover, the timing controller 140 also outputs the timing control signal to the scanning driving circuit 150 and the data driving circuit 160, and outputs the data signal to the data driving circuit 160. The scanning driving circuit 150 generates and applies scanning signals to the scanning line 115 according to the timing control signal so as to activate the pixels 114 row by row. The data driving circuit 160 converts the data signal into data voltages and outputs the data voltages to the data lines 116 to charge the activated pixels 114. Upon receiving the data voltages, the pixels 114 in each left-eye image region 111, the right-eye image region 112, and the switchable region 113 display a gray sub-image corresponding to the 2D image data, such that the pixels 114 in whole pixel matrix display a 2D gray image corresponding to the 2D image data.

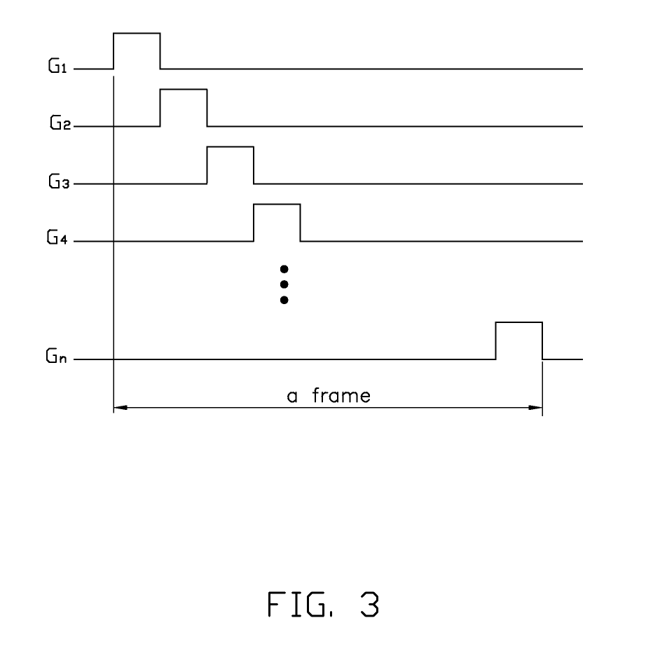

Referring to FIG. 3, a first exemplary timing chart of scanning signals provided to the scanning lines 115 during a frame period is shown. In the illustrated embodiment, whether in the 3D mode or the 2D mode, during a frame period, the scanning driving circuit 150 provides the scanning signals to the n rows of scanning lines 115 in turn. In other words, whether in the 3D mode or the 2D mode, during a frame period, each of the scanning lines 115 is provided with a corresponding scanning signal, and the n rows of scanning lines 115 are provided with the scanning signals from the first scanning line G1, the second scanning line G2 to the nth scanning line Gn.

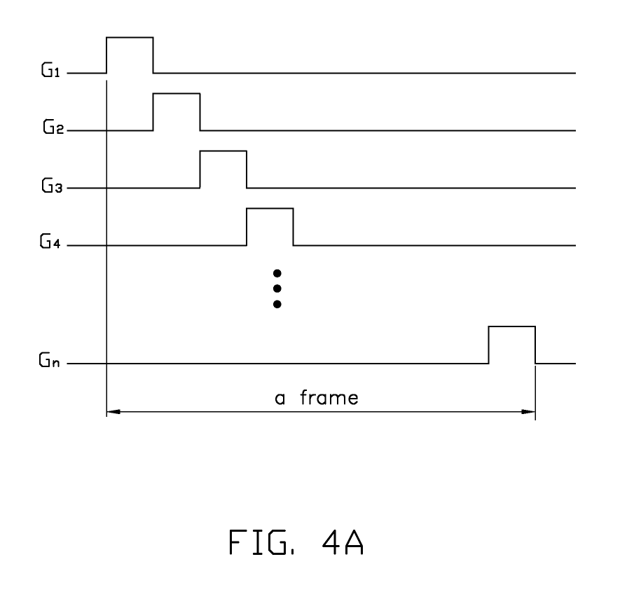

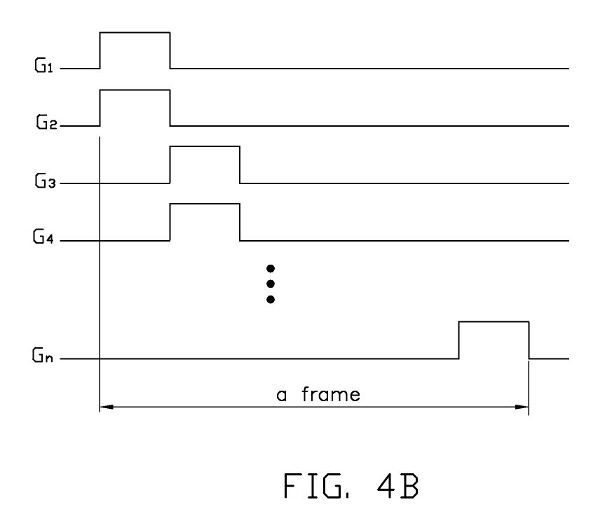

Referring to FIG. 4A and FIG. 4B, a second exemplary timing chart of scanning signals provided to the scanning lines 115 during a frame period in the 3D mode is shown in FIG. 4A, and the second exemplary timing chart of scanning signals provided to the scanning lines 115 during a frame period in the 2D mode is shown in FIG. 4B, differing from the timing chart shown in FIG. 3 only in that when the 2D-3D switchable display device 100 is in the 2D mode, all of odd-row scanning lines 115 are provided with scanning signals in turn, all of even-row scanning lines 115 are provided with scanning signals in turn, and the odd-row scanning line G(2i-1) and the even-row scanning line G2i adjacent to the odd-row scanning line G(2i-1) are provided with two scanning signals at the same time. Accordingly, the rows of pixels 114 corresponding to the odd-row scanning line G(2i-1) and the rows of pixels 114 corresponding to the even-row scanning line G(2i) display the same gray sub-image. The (2i)th row of the pixels 114 in the switchable region 113 displays a gray sub-image matching a gray sub-image displayed by the (2i-1)th row of the pixels 114 in the right-eye image region 111 or the left-eye image region 112.

With the timing chart shown in FIG. 4, two adjacent scanning lines G(2i-1) and G2i are provided with the scanning signals at the same time in the 2D mode, and accordingly, a period of each scanning signal provided to the scanning line 115 in the 2D mode can be greater than that of in the 3D mode. Thus, a charge time of each pixel 114 in the 2D mode is greater than that of in the 3D mode, and 2D image quality of the 2D-3D switchable display device 100 is maximized.

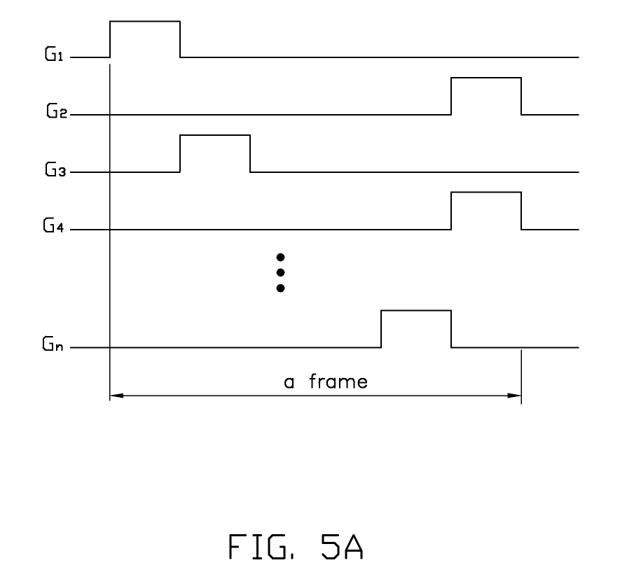

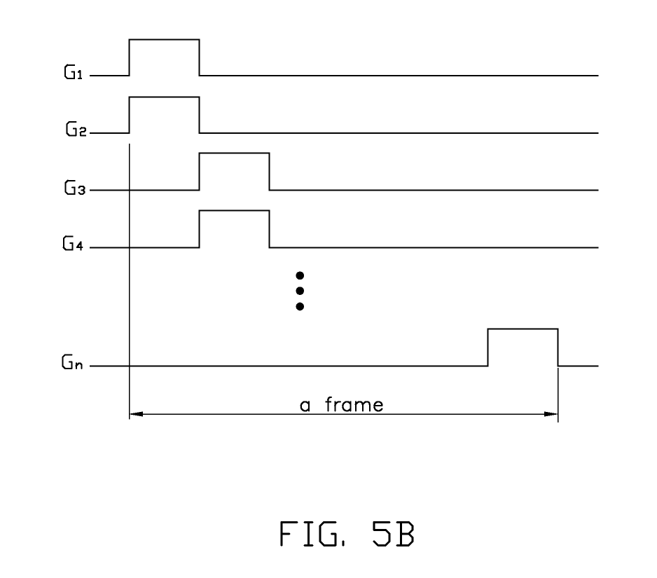

Referring to FIG. 5A and FIG. 5B, a third exemplary timing chart of scanning signals provided to the scanning lines 115 during a frame period in the 3D mode is shown in FIG. 5A, and the third exemplary timing chart of scanning signals provided to the scanning lines 115 during a frame period in the 2D mode is shown in FIG. 5B, differing from that shown in FIG. 4A and FIG. 4B only in that when the 2D-3D switchable display device 100 is in the 3D mode, in a frame time period, scanning lines corresponding to rows of the pixels of the left-eye image regions 111 and the right-eye image regions 112 are provided with scanning signals in turn, and scanning lines corresponding to the rows of the pixels of the switchable regions 113 are then provided with scanning signals at a same time which is after all of the pixels in the left-eye image regions 111 and the right-eye image regions 112 are provided with the scanning signals. For example, all of odd-row scanning lines 115 are provided with scanning signals in turn, all of even-row scanning lines 115 are provided with scanning signals after the odd-row scanning lines 115 are provided with the scanning signals, and all of even-row scanning lines 115 are provided with the scanning signals at the same time.

With the timing chart shown in FIG. 5, because all even-row scanning lines 115 are provided with the scanning signals at the same time, the pixels 114 in the switchable regions 113 can be provided with black data voltages at the same time. Accordingly, a period of each scanning signal provided to the scanning line 115 in the 3D mode can be increased, and a charge time of each pixel 114 in the 3D mode can be increased. Thus, 3D image quality of the 2D-3D switchable display device 100 is maximized.

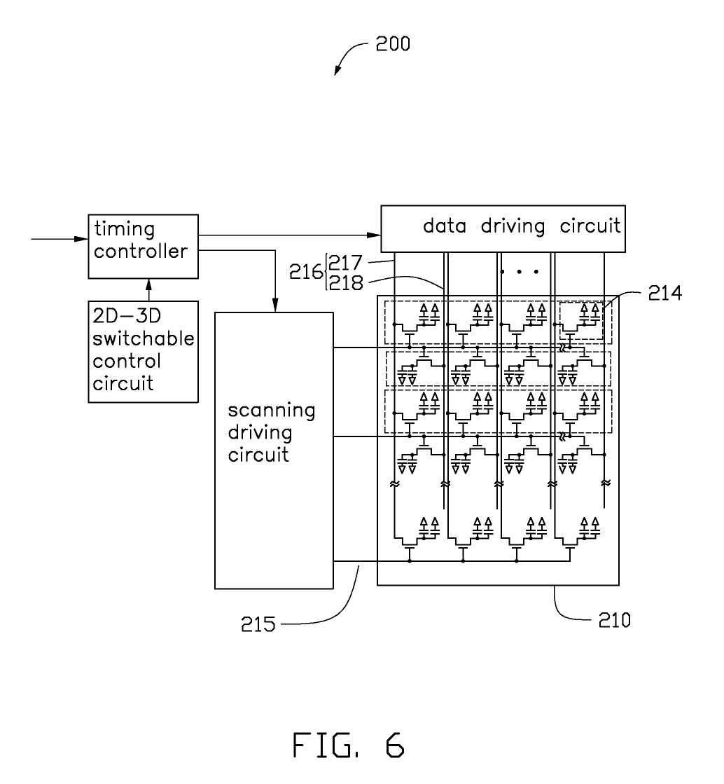

Referring to FIG. 6, a partial schematic circuit diagram of a 2D-3D switchable display device according to a second embodiment of the present disclosure is shown, differing from display device 100 shown in FIG. 2 only in that each scanning line 215 corresponds to two adjacent rows of pixels 214 and is configured to provide a scanning signal to activate the two adjacent rows of pixels 214 at the same time, data lines of a display panel 210 are divided to a plurality of data line groups 216 each including a first data line 217 and a second data line 218, and two pixels 214 of the two adjacent rows in a same column are charged by a corresponding first data line 217 and a corresponding second data line 218 of the data line group 216.

With the configuration disclosed, because each scanning line 215 corresponds to two adjacent rows of pixels 214, the number of the scanning lines 215 in the 2D-3D switchable display device 200 is half the number of rows of pixel matrix. Accordingly, whether in the 3D mode or the 2D mode, a period of each scanning signal provided to the scanning signal and a charge time of each pixel 114 can be increased. Thus, 3D image quality and 2D image quality of the 2D-3D switchable display device 100 is maximized.

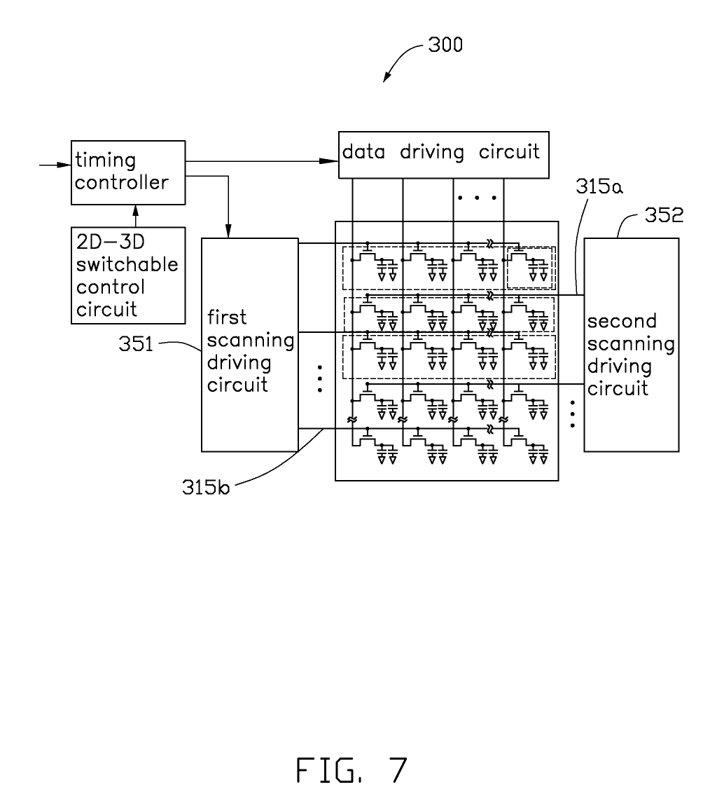

Referring to FIG. 7, a partial schematic circuit diagram of a 2D-3D switchable display device according to a third embodiment of the present disclosure differs from 2D-3D switchable display device 100 shown in FIG. 2 only in that the 2D-3D switchable display device 300 includes a first scanning driving circuit 351 configured to provide a plurality of scanning signals to odd-row scanning lines 315a and a second driving circuit 352 configured to provide a plurality of scanning signals to even-row scanning lines 315b.

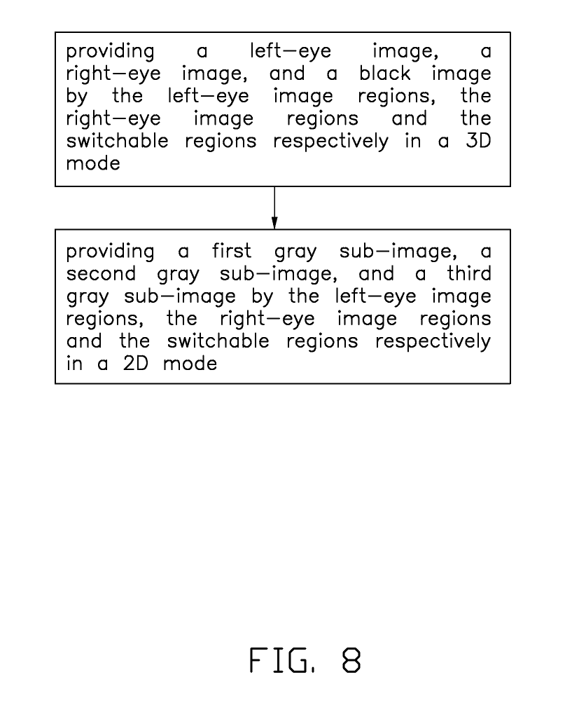

FIG. 8 shows a method for driving a 2D-3D switchable display device according to the present disclosure, as follows. It is noted that details of steps in FIG. 6 can be found in the above description of the operation of the 2D-3D switchable display device 100.

Referring to FIG. 8, the method may include: in step S1, providing a left-eye image, a right-eye image, and a black image by the left-eye image regions, the right-eye image regions and the switchable regions respectively in a 3D mode; and in step S2, providing a first gray sub-image, a second gray sub-image, and a third gray sub-image by the left-eye image regions, the right-eye image regions and the switchable regions respectively in a 2D mode.

In step S1, the 2D-3D switchable display device 100 works in the 3D mode, the left-eye image regions 111 display a left-eye image, the right-eye image regions 112 display a right-eye image, and the switchable regions 113 display a black image. The first polarization regions 121 adjust the left-eye image to achieve a first polarization, and the second polarization regions 122 adjust the right-eye image to achieve a second polarization different from the first polarization, such that the left-eye image and the right-eye image can be separated from each other using polarization lenses.

In step S2, the 2D-3D switchable display device 100 works in the 2D mode, the left-eye image regions 111 display a first gray sub-image, the right-eye image regions 112 display a second gray sub-image, and the switchable regions 113 display a third gray sub-image, such that the gray sub-images displayed by the left-eye image regions 111, the right-eye image regions 112, and the switchable regions 113 constitute a 2D image corresponding to 2D image data. Specifically, each of the left-eye image regions 111, the right-eye image regions 112, and the switchable regions 113 is used as an ordinary display region to display gray sub-image based on 2D the image data. In one embodiment, each switchable region 113 can display a gray sub-image matching a gray sub-image displayed by the adjacent right-eye image region 112 or the adjacent left-eye image region 111, for example, a row of pixels 114 in each switchable region 113 display gray sub-image matching a gray sub-image displayed by an adjacent row of pixels 114 in the adjacent right-eye image region 112 or the adjacent left-eye image region 111.

It is to be further understood that even though numerous characteristics and advantages of a preferred embodiment have been set out in the foregoing description, together with details of the structures and functions of the embodiments, the disclosure is illustrative only; and that changes may be made in detail, especially in matters of shape, size and arrangement of parts within the principles of disclosure to the full extent indicated by the broad general meaning of the terms in which the appended claims are expressed.

What is claimed is:

1. A 2D-3D switchable display device, comprising:
a display panel comprising a plurality of left-eye image regions, a plurality of right-eye image regions alternating with the left-eye image regions, and a plurality of switchable regions each disposed between a corresponding right-eye image region and a left-eye image region adjacent to the corresponding right-eye image region; and
a polarization element comprising a plurality of first polarization regions corresponding to the left-eye image regions and a plurality of second polarization regions corresponding to the right-eye image regions, the first polarization regions and the second polarization regions configured to adjust a left-eye image provided by the left-eye image regions and a right-eye image provided by the right-eye image regions to achieve different polarizations such that the right-eye image and the left-eye image are separated from each other using polarization lenses,
wherein when the 2D-3D switchable display device works in a 3D mode, each switchable region displays a black sub-image; and when the 2D-3D switchable display device works in a 2D mode, each switchable region displays a gray sub-image.

2. The 2D-3D switchable display device of claim 1, wherein the display panel further comprises a pixel matrix having a plurality of pixels, each left-eye image region, each right-eye image region, and each switchable region respectively correspond to a row of pixels.

3. The 2D-3D switchable display device of claim 2, wherein when the 2D-3D switchable display device works in a 3D mode, each of the pixels in the switchable region is provided with a black insertion voltage.

4. The 2D-3D switchable display device of claim 2, wherein when the 2D-3D switchable display device works in a 2D mode, the row of pixels in each switchable region displays a gray sub-image matching a gray sub-image displayed by an adjacent row of pixels in the corresponding right-eye image region or in the left-eye image region adjacent to the corresponding right-eye image region.

5. The 2D-3D switchable display device of claim 4, wherein the switchable regions are divided to a plurality of first switchable regions and a plurality of second switchable regions alternating with the first switchable regions, the row of pixels in each first switchable region displays a gray sub-image matching a gray sub-image displayed by an adjacent row of pixels in the corresponding right-eye image region, and the row of pixels in each second switchable region displays a gray sub-image matching a gray sub-image displayed by an adjacent row of pixels in the left-eye image region.

6. The 2D-3D switchable display device of claim 2, wherein the display panel further comprises a plurality of parallel scanning lines and a plurality of parallel data lines perpendicular to the scanning lines.

7. The 2D-3D switchable display device of claim 6, wherein each scanning line corresponds to a row of the pixels and is configured to provide a scanning signal to activate the row of the pixels, and each data line corresponds to a column of pixels and is configured to provide data voltages to the column of the pixels.

8. The 2D-3D switchable display device of claim 7, wherein when the 2D-3D switchable display device works in a 3D mode, during a frame period, the plurality of scanning lines are provided with scanning signals in turn.

9. The 2D-3D switchable display device of claim 8, wherein when the 2D-3D switchable display device works in a 2D mode, during a frame period, the plurality of scanning lines are provided with scanning signals in turn.

10. The 2D-3D switchable display device of claim 8, wherein when the 2D-3D switchable display device works in the 2D mode, odd-row scanning lines are provided with scanning signals in turn, even-row scanning lines are provided with scanning signals in turn, and an odd-row scanning line G(2i-1) and an even-row scanning line G2i adjacent to the odd-row scanning line G(2i-1) are provided with the scanning signals at the same time.

11. The 2D-3D switchable display device of claim 7, wherein when the 2D-3D switchable display device works in the 3D mode, scanning lines corresponding to rows of the pixels of the left-eye image regions 111 and the right-eye image regions are provided with scanning signals in turn, and scanning lines corresponding to the rows of the pixels of the switchable regions are then provided with scanning signals at a same time which is after all of the pixels in the left-eye image regions and the right-eye image regions are provided with the scanning signals.

12. The 2D-3D switchable display device of claim 6, wherein each scanning line corresponds to two adjacent rows of pixels and is configured to provide a scanning signal to activated the two adjacent rows of pixels at the same time, data lines of a display panel are divided to a plurality of data line groups each including a first data line and a second data line, and two pixels of the two adjacent rows in a same column are charged by the first data line and the second data line of the data line group.

13. The 2D-3D switchable display device of claim 7, further comprising a timing controller configured to receive image data, output a timing control signal to the scanning driving circuit and the data driving circuit, and output a data signal to the data driving circuit, a scanning driving circuit is configured to provide the scanning signals to the scanning lines according to the timing control signal and a data driving circuit configured to provide the data voltages to the data lines according to the timing control signal and the data signal.

14. The 2D-3D switchable display device of claim 13, further comprising a 2D-3D switchable control circuit configured to provide a display mode control signal to the timing controller, wherein the timing controller is further configured to process the image data according to the display mode control signal, and generate the timing control signal and the data signal.

15. The 2D-3D switchable display device of claim 14, wherein the 2D-3D switchable control circuit are further configured to receive image data and determine that the image data are 3D image data or 2D image data so as to generate the display mode control signal.

16. The 2D-3D switchable display device of claim 7, further comprising a first scanning driving circuit configured to provide the scanning signals to odd-row scanning lines and a second scanning driving circuit configured to provide the scanning signals to even-row scanning lines.

17. The 2D-3D switchable display device of claim 1, wherein the polarization element further comprises a plurality of dummy regions corresponding to the switchable regions, and each of the dummy regions is a light transmission region.

18. The 2D-3D switchable display device of claim 1, wherein a width of each left-eye image region is the same as that of each right-eye image region, and is greater than that of each switchable region.

19. The 2D-3D switchable display device of claim 18, wherein an area ratio of the switchable region to each left-eye image region is in the range from greater than or equal to 0.1 to less than or equal to 0.5.

20. A method for driving a 2D-3D switchable display device, the 2D-3D switchable display device comprising a display panel and a polarization element, the display panel comprising a left-eye image region, a right-eye image region, and a switchable region disposed between the left-eye image region and the right-eye image region, the polarization element comprising a first polarization region configured to adjust light from the left-eye image region to achieve a first polarization and a second polarization region configured to adjust light from the right-eye image region to achieve a second polarization different from the first polarization, the method comprising:
providing a left-eye image, a right-eye image, and a black image by the left-eye image region, the right-eye image region and the switchable region respectively in a 3D mode of the 2D-3D switchable display device; and
providing a first gray sub-image, a second gray sub-image, and a third gray sub-image by the left-eye image region, the right-eye image region, and the switchable region respectively in a 2D mode of the 2D-3D switchable display device.
